(19) United States
(12) Patent Application Publication
(10) Pub. No.: US 2008/0112637 A1
(43) Pub. Date: May 15, 2008

(54) Image Processor

(75) Inventor: Gen Horie, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/006,872

(22) Filed: Jan. 7, 2008

Related U.S. Application Data
(63) Continuation of application No. PCT/JP2006/314935, filed on Jul. 21, 2006.

(30) Foreign Application Priority Data
Jul. 21, 2005 (JP) 2005-210709

(51) Int. Cl. G06K 9/40

(52) U.S. Cl. 382/260

(57) ABSTRACT

An image taken via lens system (100) and CCD (101) is converted at A/D (102) into digital signals that are then stored in buffer (103). The output of buffer (103) is entered in output block (106) via noise reduction processing block (104) and signal processing block (105) in order. In noise reduction processing block (104), a low-frequency component is created at a low-frequency component creation block and high-frequency components are created at a high-frequency component creation block. At a threshold setting block, thresholds are set for the high-frequency components in each similar direction. Further, on the basis of the set thresholds, the high-frequency components are transformed at the high-frequency component transform block, and the low-frequency component and the high-frequency components to which transform processing has been applied are synthesized together at a synthesis block.

### ART FIELD

The present invention relates to an image processor adapted to separate the image to be processed into multiple frequency components and apply image processing such as noise reduction processing to them.

### BACKGROUND ART

For image processing, various proposals have been put forward of how to reduce noises included in images. For instance, U.S. Pat. No. 3,193,806 shows that an image is broken down into detail images at a multi-resolution level, and a noise variance is found from a local variance histogram. After transform processing is applied to each detail image by a noise inhibition function with the thus found noise variance as a parameter, all detail images are synthesized together to hold back the noise included in the image. By implementing such processing, image details indicative of useful information are hold and the noise included in each detail image is reduced.

However, one problem with the prior art described in that U.S. Pat. No. 3,193,806 is that because one transform function is used for each detail image, it is impossible to prevent artifacts that result from the remnants of a component ascribable to noise in a specific direction. Another problem with the prior art is that because the transform function is found from each detail image alone, it often gives rise to an extreme transform result that renders noise reductions insufficient, and lets information about the details of an image disappear.

With such problems with the prior art in mind, the present invention has for its object the provision of an image processor that allows for prevention of artifacts resulting from noises, and a sensible tradeoff between proper noise reductions and maintaining image details.

### DISCLOSURE OF THE INVENTION

(1) To accomplish the aforesaid object, the present invention provides an image processor, characterized by comprising a low-frequency component creation block for creating from an image of interest a low-frequency component of said image of interest, a high-frequency component creation block for creating from said image of interest at least two high-frequency components of said image of interest, a high-frequency component transform block for enhancing or inhibiting an element of said at least two high-frequency components, which element has a given absolute value range at a given high-frequency component, a threshold setting block for setting at least two thresholds that determine said given absolute value range for a high-frequency component of said at least two high-frequency components, which lies along mutually similar directions, and an image generation block for using said at least two high-frequency components after transformed at said high-frequency component transform block and said image of interest or said low-frequency component to generate an image.

The invention (1) is embodied in the form of the first to fifth embodiments. It is the low-frequency extraction block 200 that is corresponding to the low-frequency component creation block in the arrangement of the invention (1). It is the horizontal/vertical high-frequency extraction block 201, 45° oblique high-frequency extraction block 203, 135° oblique high-frequency extraction block 205, horizontal high-frequency extraction block 401, vertical high-frequency extraction block 403 and oblique high-frequency extraction block 405 that are corresponding to the high-frequency component creation block. Further, it is the horizontal/vertical high-frequency transform block 202, 45° oblique high-frequency transform block 204, 135° oblique high-frequency transform block 206, horizontal high-frequency transform block 402, vertical high-frequency transform block 404 and oblique high-frequency transform block 406 that are corresponding to the high-frequency component transform block. Furthermore, it is the horizontal/vertical high-frequency threshold computation block 309, residual high-frequency threshold computation block 900, high-frequency threshold computation block 451, horizontal high-frequency threshold computation block 471, vertical high-frequency threshold computation block 472 and oblique noise quantity estimation block 825 that are corresponding to the high-frequency component transform block, and it is the synthesis block 209 that is corresponding to the image generation block.

According to the invention (1), a low-frequency component is created at the low-frequency component creation block, and high-frequency components are created at the high-frequency component creation block. Thresholds are set at the threshold setting block for high-frequency components for each similar direction. Further, the transform processing of high-frequency components is implemented at the high-frequency component transform block on the basis of the set threshold. Finally, the aforesaid low-frequency component and the high-frequency components to which transform processing has been applied are synthesized together at the synthesis block. According to this arrangement, thresholds are created for the high-frequency components for each similar direction, so that the component in a specific direction is prevented from remaining, thereby preventing the occurrence of artifacts.

According to this invention, the thresholds are created for the high-frequency components for each similar direction, so that the component in a specific direction is prevented from remaining, thereby preventing the occurrence of artifacts. It is thus possible to provide an image process that allows for prevention of artifacts resulting from noises and a sensible tradeoff between proper noise reductions and holding image details.

### BRIEF DESCRIPTION OF THE DRAWINGS

FIG. 1 is illustrative of the architecture of the first embodiment.

FIG. 2 is illustrative of the setup of a part of FIG. 1.

FIG. 3 is illustrative of the Bayer arrangement block.

FIG. 4 is illustrative of one example of the low-frequency extraction filter.

FIG. 5 is illustrative of one example of the residual high-frequency extraction filter.

FIG. 6 is illustrative of one example of the horizontal/vertical high-frequency extraction filter.

FIG. 7 is illustrative of the setup of a part of FIG. 2.

FIG. 8 is illustrative of the setup of a part of FIG. 7.

FIG. 9 is illustrative of the setup of a part of FIG. 2.

FIG. 10 is a characteristics diagram illustrative of one exemplary noise model.

FIG. 11 is a characteristics view illustrative of the probability of occurrence of noise.

FIG. 12 is a characteristics view illustrative of an amplitude distribution for noises and edges.

FIG. 13 is a characteristics view illustrative of one exemplary coring transform processing.

FIG. 14 is illustrative of the architecture of the second embodiment of the invention.

FIG. 15 is illustrative of the Bayer arrangement block.

FIG. 16 is illustrative of how to generate a color difference signal.

FIG. 17 is illustrative of the processing unit block for a color difference signal.

FIG. 18 is illustrative of one example of the low-frequency extraction filter.

FIG. 19 is illustrative of one example of the high-frequency extraction filter.

FIG. 20 is illustrative of the architecture of the third embodiment.

FIG. 21 is illustrative of the setup of a part of FIG. 20.

FIG. 22 is illustrative of the architecture of the fourth embodiment.

FIG. 23 is illustrative of the architecture of the fifth embodiment.

FIG. 24 is illustrative of the setup of a part of FIG. 23.

FIG. 25 is a characteristics view illustrative of one exemplary noise model.

### BEST MODE FOR CARRYING OUT THE INVENTION

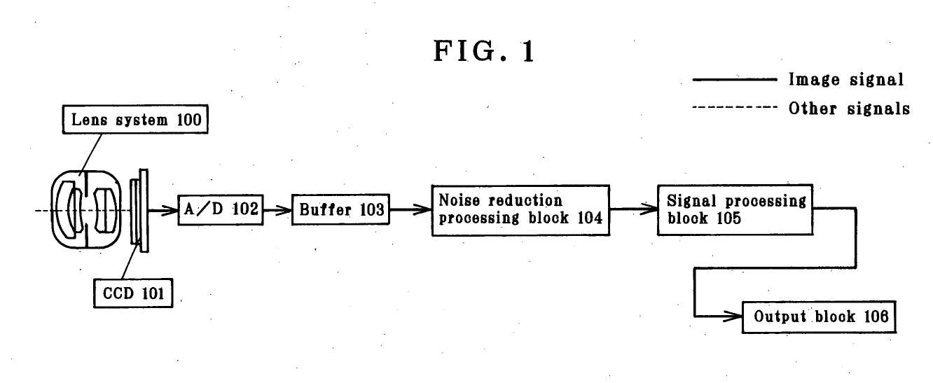

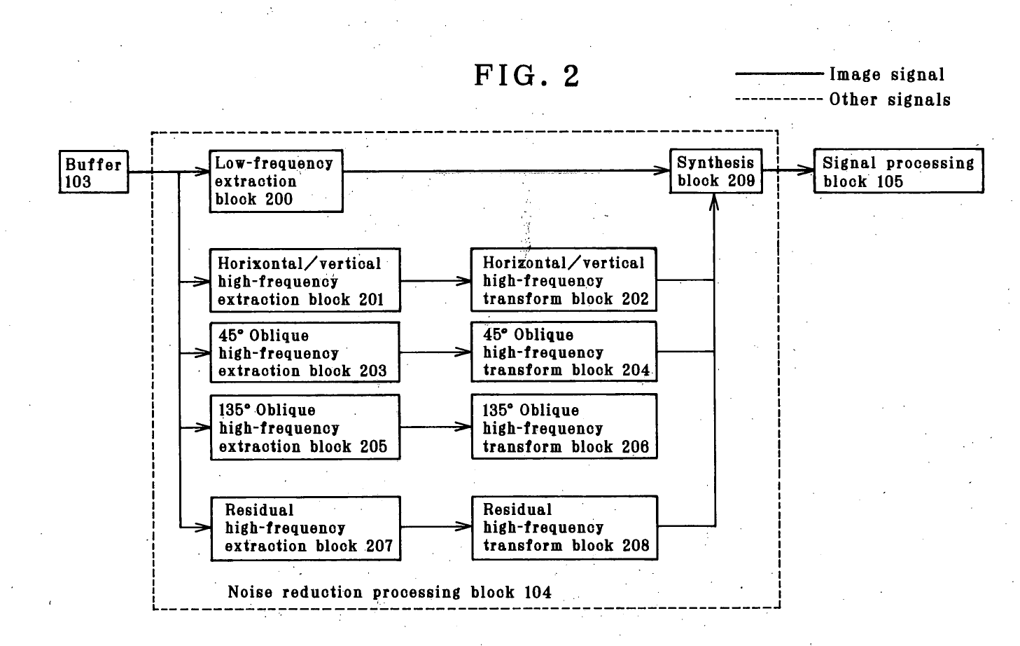

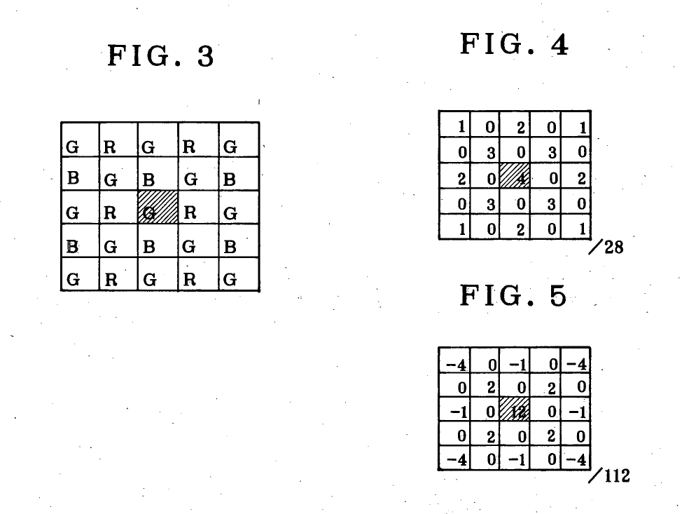

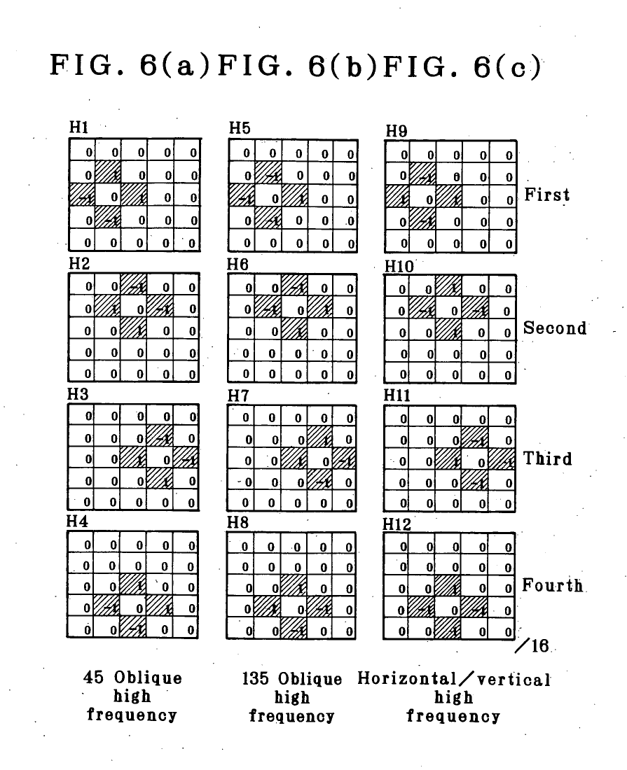

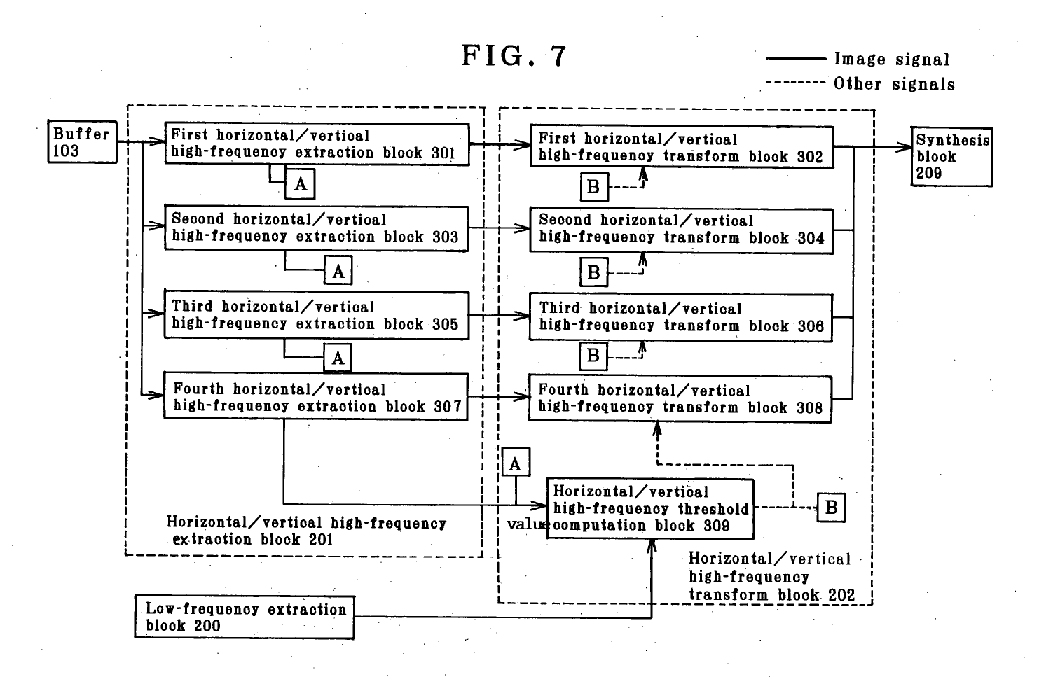

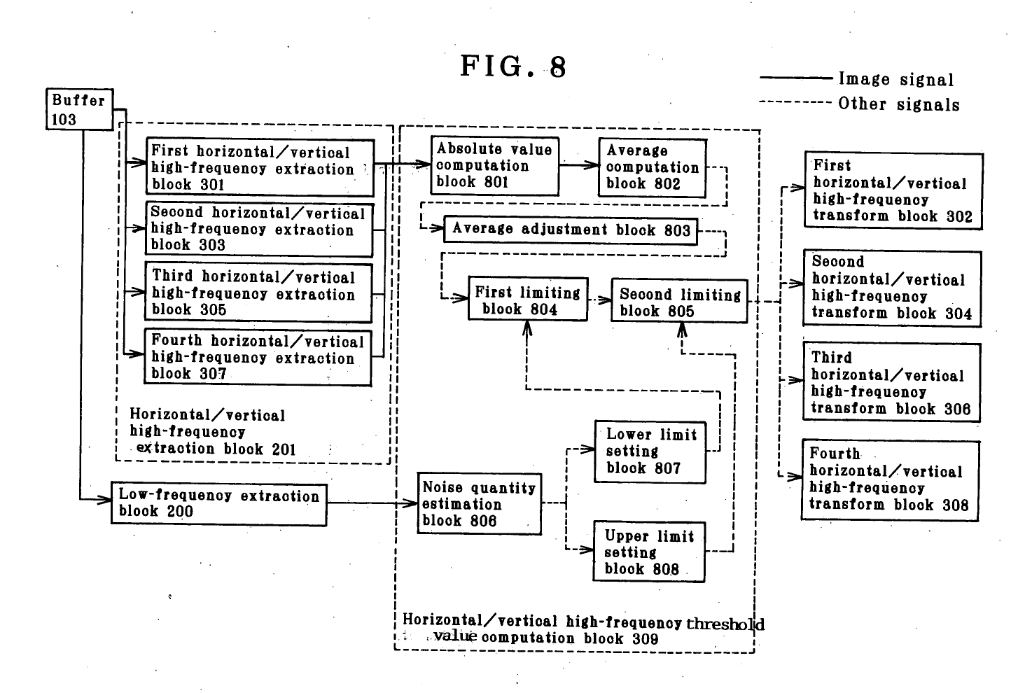

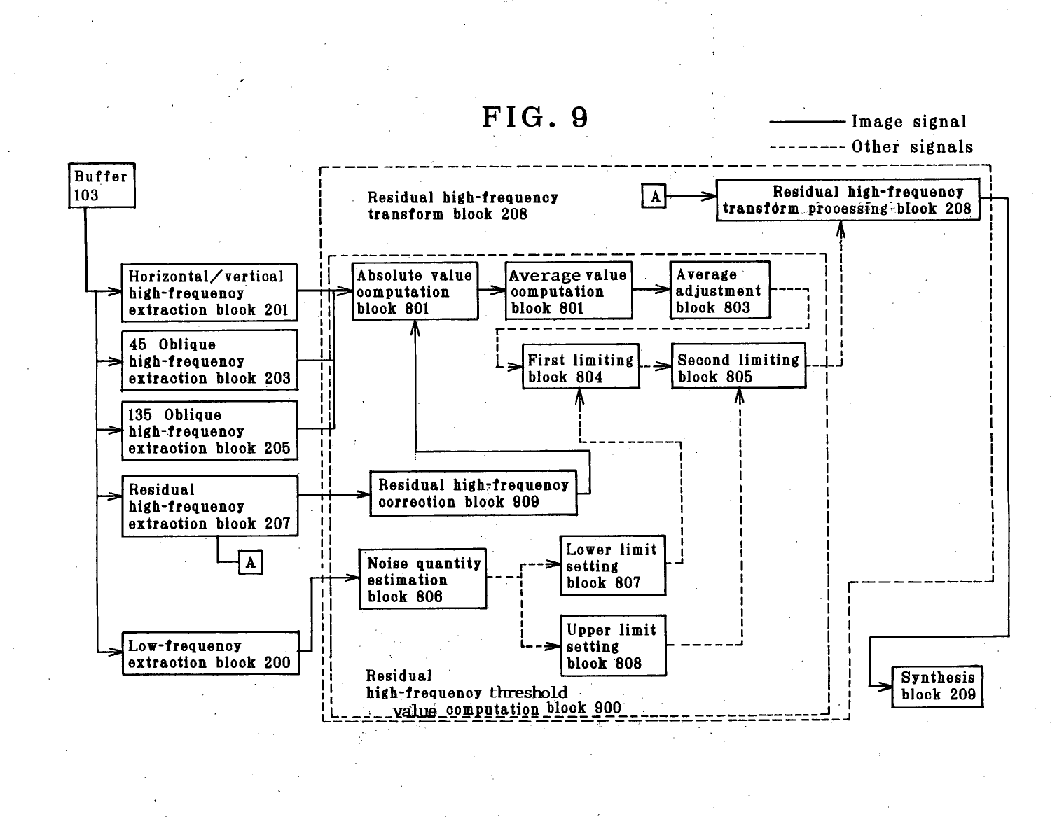

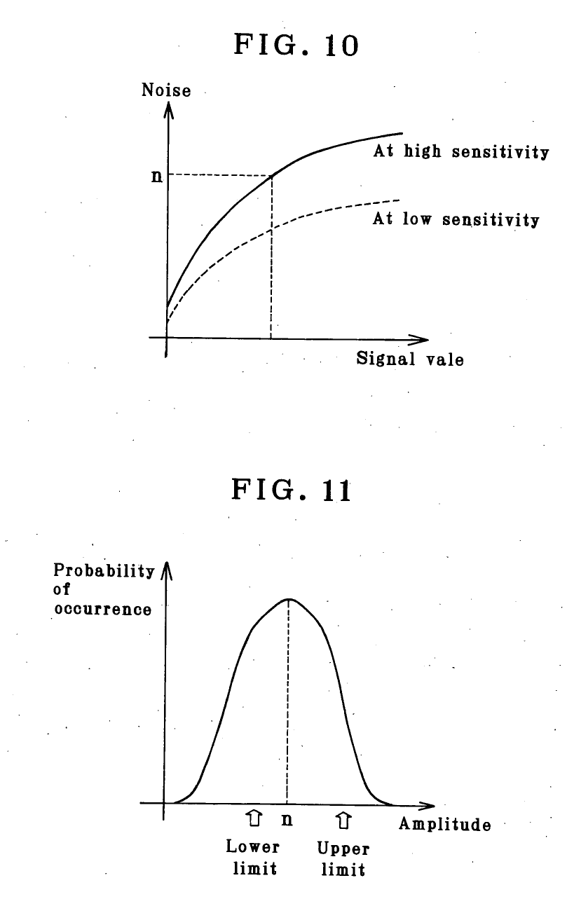

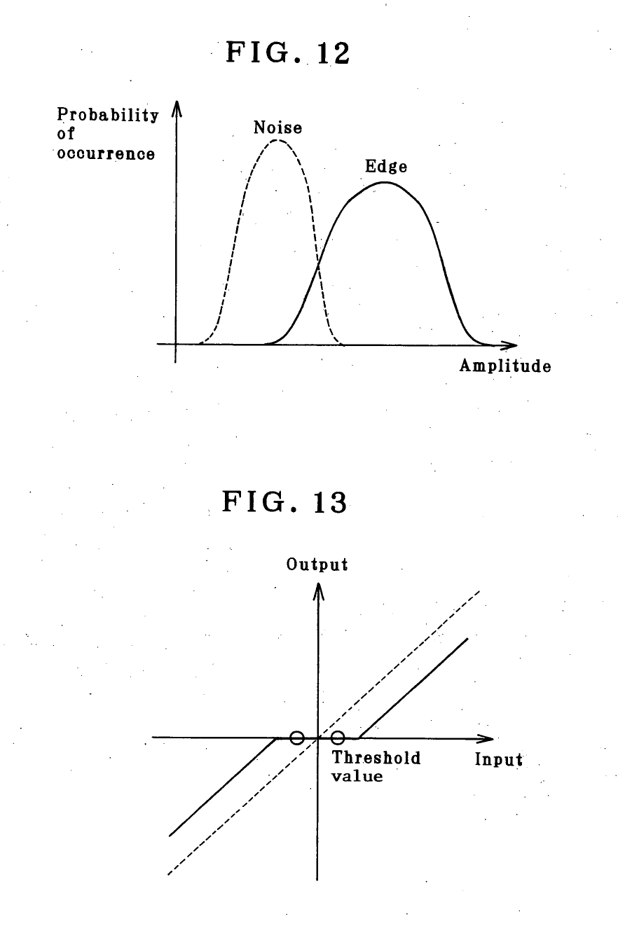

The first embodiment of the invention is now explained with reference to the drawings. FIGS. 1 to 13 are illustrative of the first embodiment. FIG. 1 is illustrative of the architecture of the first embodiment of the invention; FIG. 2 is illustrative of the setup of a part of FIG. 1; FIG. 3 is illustrative of the Bayer arrangement block; FIG. 4 is illustrative of one example of the low-frequency extraction filter; FIG. 5 is illustrative of one example of the residual high-frequency extraction filter; FIG. 6 is illustrative of one example of the high-frequency extraction filter; FIG. 7 is illustrative of the setup of a part of FIG. 2; FIG. 8 is illustrative of the setup of a part of FIG. 7; FIG. 9 is illustrative of the setup of a part of FIG. 2; FIG. 10 is a characteristics diagram illustrative of one exemplary noise model; FIG. 11 is a characteristics view illustrative of the probability of occurrence of noise; FIG. 12 is a characteristics view illustrative of an amplitude distribution for noise and edges; and FIG. 13 is a characteristics view illustrative of one exemplary coring transform processing.

FIG. 1 is illustrative of the architecture of the first embodiment. The embodiment here is assumed to be mounted on a digital camera for the purpose of achieving a function of taking images of subjects and recording the ensuing digital data in a recording medium. An image taken via a lens system 100 and CCD 101 is converted at A/D 102 into digital signals that are in turn stored in a buffer 103. The output from the buffer 103 is entered in an output block 106 via a noise reduction processing block 104 and a signal processing block 105 in this order. Further, a control block built up of a microcomputer (not shown), etc. is bidirectionally connected to each block.

An image signal read out of the buffer 103 is subjected at the noise reduction processing block 104 to noise reduction processing by which noise contained in the image signal is reduced, and at the signal processing block 105, known signal processing such as white balance processing, color correction processing and compression processing is in turn applied to the image signal that is then stored at the output block 106 in the recording medium. Noise reduction processing is implemented with an area comprising as the unit to be processed a Bayer arrangement of 5 pixels×5 pixels, like one shown in FIG. 3. Once noise reduction processing has been implemented, the signal of a G pixel at the center of the area is transformed. While the area is moved by two pixels, similar processing is repeatedly implemented so that noise reduction processing is applied to all over the image. Such noise reduction processing is implemented on the basis of control by the control block.

FIG. 2 is illustrative of the setup of the noise reduction processing block 104. The noise reduction processing block 104 separates an image signal read out of the buffer 103 into multiple frequency components, then applying transform processing to each of them, and finally re-synthesizing them for noise reduction. The frequency separation here is implemented by a high-frequency extraction filter having directionality, with different transform processing applied in each direction.

In FIG. 2, a low-frequency extraction block 200 applies the low-frequency filter depicted in FIG. 4 to the image signal read out of the buffer 103 to extract a low-frequency component. The low-frequency component extracted at the low-frequency extraction block is forwarded to a synthesis block 209. A high-frequency extraction block is built up of a horizontal/vertical high-frequency extraction block 201, a 45° oblique high-frequency extraction block 203, a 135° oblique high-frequency extraction block 205 and a residual high-frequency extraction block 207, and a high-frequency transform block is built up of a horizontal/vertical high-frequency transform block 202, a 45° oblique high-frequency transform block 204, a 135° oblique high-frequency transform block 206 and a residual high-frequency transform block 208. The horizontal/vertical high-frequency block 201 applies horizontal/vertical high-frequency extraction filters (H9 to H12) shown in FIG. 6 to the image signal read out of the buffer 103 to extract the horizontal/vertical high-frequency component.

The horizontal/vertical high-frequency transform block 202 applies transform processing to the horizontal/vertical high-frequency component extracted at the horizontal/vertical high-frequency extraction block 202, thereby reducing the noise contained in the horizontal/vertical high-frequency component. The horizontal/vertical high-frequency component with its noise reduced is synthesized at the synthesis block 209 with other components. Note here that the coefficient 1/16 of FIG. 4 is the divisor for level adjustment subjected to bit shift computation.

Shown in FIG. 6 is a 45° oblique high-frequency extraction filter (a), a 135 oblique high-frequency extraction filter (b), and a horizontal/vertical high-frequency extraction filter (c). The horizontal/vertical high-frequency extraction filter is built up of the first to fourth high-frequency extraction filters H9 to H12. As will be explained with reference to FIG. 7, the first to fourth high-frequency extraction filters H9 to H12 are corresponding to the first to fourth horizontal/vertical high-frequency extraction blocks 301 to 307. Likewise, the 45° oblique high-frequency extraction filter is built up of the first to fourth high-frequency extraction filters H1 to H4, and the 135° oblique high-frequency extraction filter is built up of the first to fourth high-frequency extraction filters H5 to H8.

In FIG. 2, the 45° oblique high-frequency extraction block 203 applies the 45° oblique high-frequency extraction filters (H1 to H4) shown in FIG. 6 to the image signal read out of the buffer 103 to extract the 45° oblique high-frequency component. The 45° high-frequency transform block 204 applies transform processing to the 45° oblique high-frequency component extracted at the 45° oblique high-frequency extraction block 203 to reduce the noise included in the 45° oblique high-frequency component. The 45° oblique high-frequency component with its noise reduced is synthesized at the synthesis block 209 with other components.

The 135° oblique high-frequency extraction block 205 applies the 135° oblique high-frequency extraction filters (H5 to H8) shown in FIG. 6 to the image signal read out of the buffer 103 to extract the 135° oblique high-frequency component. The 135° high-frequency transform block 206 applies transform processing to the 135° oblique high-frequency component extracted at the 135° oblique high-frequency extraction block 205 to reduce the noise included in the 135° oblique high-frequency component. The 135° oblique high-frequency component with its noise reduced is synthesized at the synthesis block 209 with other components.

The residual high-frequency extraction block 207 applies the residual high-frequency extraction filter shown in FIG. 5 to the image signal read out of the buffer 103 to extract the residual high-frequency component. The residual high-frequency transform block 208 applies transform processing to the residual high-frequency component extracted at the residual high-frequency extraction block 207 to reduce the noise included in the residual high-frequency component. The residual high-frequency component with its noise reduced is synthesized at the synthesis block 209 with other components. The residual high-frequency component is the remnants of the original signal from which the low-frequency component, the horizontal/vertical high-frequency components, the 45° oblique high-frequency component and the 135° oblique high-frequency component are extracted. The residual high-frequency extraction block 207 and the residual high-frequency transform block 208 are provided to synthesize all the low-frequency component, horizontal/vertical high-frequency component, 45° oblique high-frequency component, 135° oblique high-frequency component and residual high-frequency component, thereby reconstructing the original signal impeccably.

FIG. 7 is illustrative of the architecture of the horizontal/vertical high-frequency extraction block 201 and horizontal/vertical high-frequency transform block 202. The horizontal/vertical high-frequency extraction block 201 is built up of four or the first to fourth horizontal/vertical high-frequency extraction blocks 301, 303, 305 and 307 that are corresponding to four horizontal/vertical high-frequency extraction filters (H9 to H12) such as the ones shown in FIG. 6. The horizontal/vertical high-frequency transform block 202 is built up of four or the first to fourth horizontal/vertical high-frequency transform block 302, 304, 306 and 308 and a horizontal/vertical high-frequency threshold computation block 309. The output (A) of each horizontal/vertical high-frequency transform block 302, 304, 306, 308 is entered in the horizontal/vertical high-frequency threshold computation block 309.

On the basis of a threshold (B) found out at the horizontal/vertical high-frequency threshold computation block 309, the horizontal/vertical high-frequency component extracted at the first horizontal/vertical high-frequency extraction block 301 is transformed at the first horizontal/vertical high-frequency transform block 302, and then sent out to the synthesis block 209, and on the basis of the outputs of the first to fourth horizontal/vertical high-frequency extraction blocks 301, 303, 305 and 307, the horizontal/vertical high-frequency threshold computation block 309 determines a threshold (B) used at the first to fourth horizontal/vertical high-frequency transform blocks 302, 304, 306 and 308. In FIG. 7, the threshold used for horizontal/vertical high-frequency component transform is thus determined on the basis of the horizontal/vertical high-frequency component.

The 45° oblique high-frequency extraction block 203 and 45° oblique high-frequency transform block 204 and the 135° oblique high-frequency extraction block 205 and 135° oblique high-frequency transform block 206 shown in FIG. 2, too, are similar in construction to the horizontal/vertical high-frequency extraction block 201 and horizontal/vertical high-frequency transform block 202 shown in FIG. 7. That is, the high-frequency transform block for each direction is provided with a threshold computation block (corresponding to reference numeral 309 in FIG. 7) for the high frequency in each direction.

FIG. 8 is illustrative of the setup of the horizontal/vertical high-frequency threshold computation block 309 explained with reference to FIG. 7. The outputs of the first to fourth horizontal/vertical high-frequency extraction blocks 301, 303, 305 and 307 are transformed at an absolute value computation block 801 into absolute values, and an average of the four absolute values is computed at an average computation block 802. At an average adjustment block 803, the average is adjusted on the basis of an adjustment value given from the control block. In the embodiment here, the output of the average computation block 802 is multiplied by the adjustment value. This adjustment value is a value for adjusting the intensity of processing implemented at the first to fourth horizontal/vertical high-frequency transform blocks 302, 304, 306 and 308, and for it the predetermined value is set in such a way as to give the desired image quality.

The horizontal/vertical high-frequency threshold computation block 309 of FIG. 8 is provided with the absolute value computation block 801, the average computation block 802, the average adjustment block 803, a first limiting block 804, a second limiting block 805, a noise quantity estimation block 806, a lower limit setting block 807, and an upper limit setting block 808.

At the noise quantity estimation block 806, the quantity of noise assumed to be included in the image signal is estimated on the basis of the output of the low-frequency extraction block 200 and a noise mode set at the control block. As shown in FIG. 10, the noise model provides the quantity of noise assumed to be included in the image signal as an image signal level function: it is preset on the basis of theoretical calculation or practical measurement. As can be seen from FIG. 10, the noise model is selected depending on the setting of a camera's photographic sensitivity (at high or low sensitivity).

The quantity of noise estimated at the noise quantity estimation block 806 is added to the lower limit setting block 807 or the upper limit setting block 808. At the lower limit setting block 807, there is the lower limit of the threshold computed on the basis of the quantity of noise. The lower limit of the threshold corresponds to a signal indicating that signals having smaller amplitudes are all taken as noise. At the upper limit setting block 808, the upper limit of the threshold is computed on the basis of the quantity of noise. The upper limit of the threshold corresponds to a signal indicating that signals having larger amplitudes are all taken as the original information included in the image, not as noise.

The lower limit figured out at the lower limit setting block 807, and the upper limit figured out at the upper limit setting block 808 is determined on the basis of the statistical nature of noise: it is preset as a coefficient value based on the quantity of noise found from the noise model. As shown in FIG. 12, the aforesaid lower and upper limits are set on the basis of a difference in the amplitude value histogram between the noise and the edge (the original information included in the image).

Generally speaking, the noise has a high peak at an area of small amplitude value whereas the edge has a peak at an area whose amplitude value is larger than that. While the amplitude distribution for the noise overlaps that for the edge, it is desired that the amplitude having a frequency of occurrence fully reduced on the lower end side of the edge distribution be set as the lower limit and the amplitude having a frequency of occurrence fully reduced at the upper end of the noise distribution be set as the upper limit.

In FIG. 8, the lower limit set at the lower limit setting block 807 is sent out to the first limiting block 804, and the upper limit set at the upper limit setting block 808 is sent out to the second limiting block 805. The output of the average adjustment block 803 is compared at the first limiting block 804 with the lower limit, and if it is smaller than the lower limit, it is then converted to the lower limit. The output of the first limiting block 804 is compared at the second limiting block 805 with the upper limit, and if it is larger than the upper limit, it is then converted into the upper limit.

The arrangement corresponding to the aforesaid horizontal/vertical high-frequency threshold computation block 309 is included in the 45° oblique high-frequency transform block 204, and the 135° oblique high-frequency transform block 206, too. That is, each includes a high-frequency extraction block and a high-frequency transform block for each direction, similar in construction to the horizontal/vertical high-frequency extraction block and the horizontal/vertical high-frequency transform block explained with reference to FIG. 7, with the high-frequency transform block for each direction provided a high-frequency threshold computation block for each direction. The high-frequency threshold computation block for each direction works the same way as the horizontal/vertical high-frequency threshold computation block 309, so that the threshold used for the transform processing of each high-frequency component is worked out on the basis of the high-frequency component in each direction.

FIG. 9 is illustrative of the setups of the residual high-frequency extraction block 207 and the residual high-frequency transform block 208. A residual high-frequency threshold computation block 900 of FIG. 9 is different from the horizontal/vertical high-frequency threshold computation block 309 of FIG. 8 in that the signal entered in the absolute value computation block 801 is for every high-frequency component from the horizontal/vertical high-frequency component to the 45° oblique high-frequency component to the 135° oblique high-frequency component to the residual high-frequency component, not for the high-frequency component in a specific direction. Another difference is that there is a residual high-frequency correction block 909 provided in which the output of the residual high-frequency extraction block 207 is entered. The residual high-frequency correction block 909 has a gain adjustment function of adjusting a given high-frequency component.

Other than the residual high-frequency correction block 909, the rest of FIG. 9, i.e., the absolute value computation block 801, average computation block 802, average adjustment block 803, first limiting block 804, second limiting block 805, noise quantity estimation block 806, lower limit setting block 807 and upper limit setting block 808 are similar in construction to those of FIG. 8. Note here that the residual high-frequency component extracted at the residual high-frequency extraction block 207 is entered in the residual high-frequency transform processing block 208.

The residual high-frequency threshold computation block 900 of FIG. 9 being thus constructed, the threshold used for the transform processing of the residual high-frequency component is determined on the basis of all the high-frequency components. The residual high-frequency extraction filter forming the residual high-frequency extraction block 207 shown in FIG. 5 differs in filter gain from other high-frequency extraction filters shown in FIG. 6. At the residual high-frequency correction block 909, the residual high-frequency component is therefore corrected in such a way as to be equal in gain to other high-frequency components.

FIG. 13 is illustrative of coring processing that is threshold processing implemented at the horizontal/vertical high-frequency transform block 202, 45° oblique high-frequency transform block 204, 135 oblique high-frequency transform block 206 and residual high-frequency transform block 208. By such coring processing, signals (encircled in FIG. 13) that are less than the threshold and so taken as noise are deleted so that the noise included in the image signal can be reduced.

Referring to FIG. 9, after the aforesaid processing at the residual high-frequency transform block 208, the low-frequency component is synthesized at the synthesis block 209 with the high-frequency component to which transform processing has been applied at the residual high-frequency transform block 208, as described with reference to FIG. 2, whereby there can be an image signal obtained with its noise reduced.

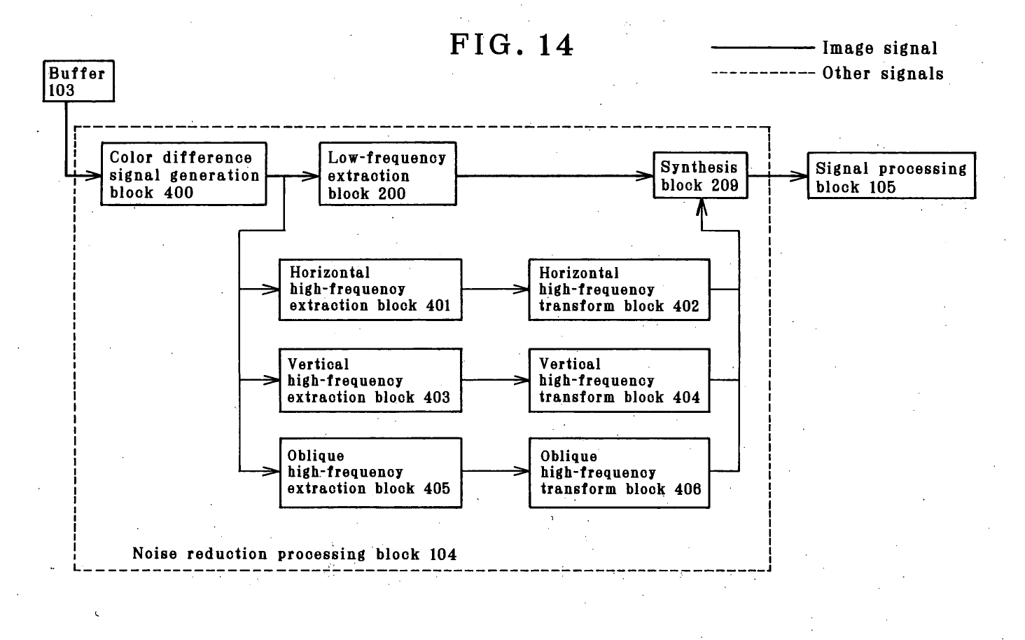

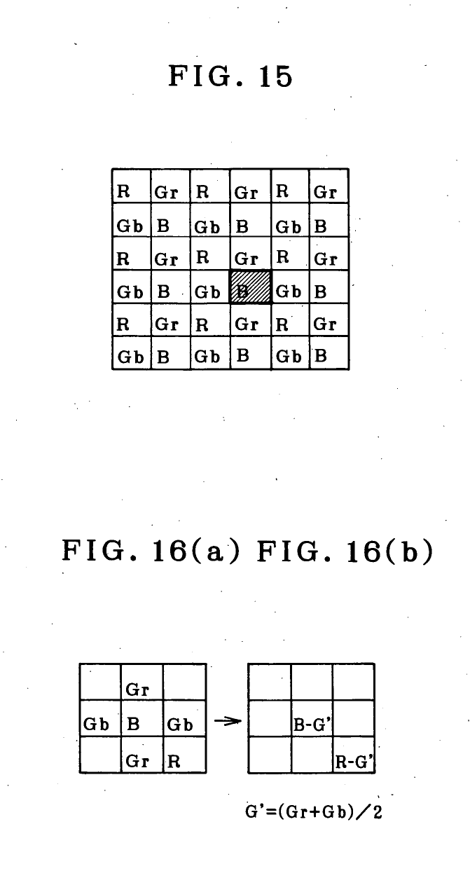

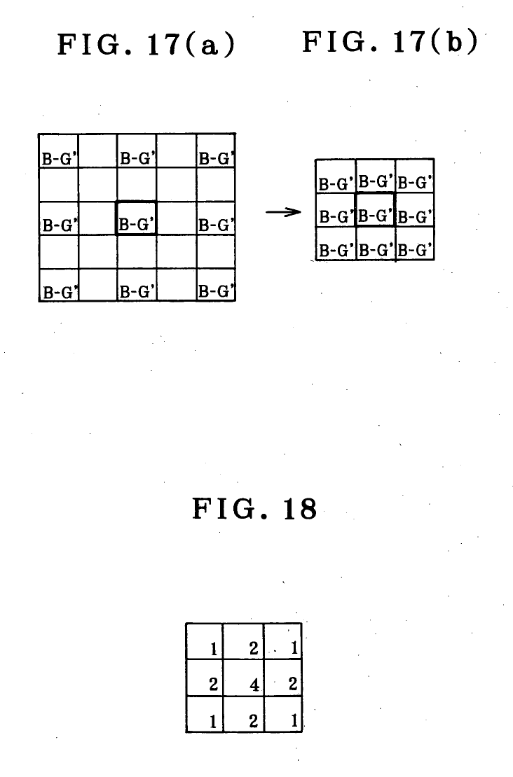

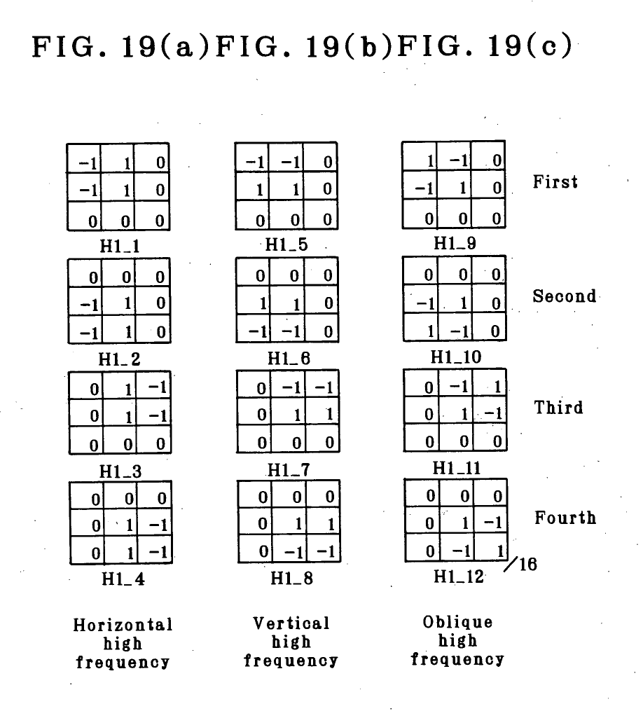

FIGS. 14 to 19 are illustrative of the second embodiment; FIG. 15 is illustrative of the Bayer arrangement block; FIG. 16 is illustrative of how to create a color difference signal; FIG. 17 is illustrative of the processing unit block for a color difference signal; FIG. 18 is illustrative of one example of the low-frequency extraction filter; and FIG. 19 is illustrative of one example of the high-frequency extraction filter.

Shown in FIG. 14 is a noise reduction processing block 104 in the second embodiment of the invention. This processing block 104 differs from the noise reduction processing block 104 in the first embodiment of FIG. 2 in that it includes a color difference signal generation block 400, the high-frequency component is separated in three directions: horizontal, vertical and oblique, and there is none of the residual high-frequency component. Further, the Bayer arrangement block that is the processing unit comprises 6 pixels×6 pixels, as shown in FIG. 15.

Referring to FIG. 14, the color difference signal generation block 400 uses a signal value for R or B that is a pixel of interest and a signal value for G to the left and above, as shown in FIG. 16, to generate a color difference signal R-G′ or B-G′. Note here that G′ is an average of two G pixels. Further, as shown in FIG. 17, 3 pixels×3 pixels are produced as a processing block for one color difference signal.

A low-frequency extraction block 200 of FIG. 14 is built up of a filter shown in FIG. 18. A horizontal high-frequency extraction block 401 is built up of high-frequency filters H1_1 to H1_4 of FIG. 19. A vertical high-frequency extraction block 403 is built up of high-frequency extraction filter H1_5 to H1_8 of FIG. 19, and an oblique high-frequency extraction block 405 is built up of high-frequency extraction filters H1_9 to H1_12 of FIG. 19.

Referring to the noise reduction processing block 104 shown in FIG. 14, the high-frequency extraction blocks 401 to 405 in the horizontal, vertical and oblique directions are similar in construction and action to the horizontal/vertical high-frequency extraction block 201 shown in FIG. 7 with the exception that the processing block differs in size and filter coefficient. And the horizontal, vertical and oblique high-frequency transform blocks 402, 404 and 406 are similar in construction and action to the horizontal/vertical high-frequency transform block 202 shown in FIG. 7. That is, the noise reduction processing block 104 comprises the first to fourth high-frequency transform blocks and a high-frequency threshold computation block.

It is here noted that inverse transform to that shown in FIG. 16 is implemented at the signal processing block 105 of FIG. 14 so that primary colors signals R and B are regenerated from the color difference signals R-G′ and B-G′. Thus, as the frequency transform processing explained with reference to FIG. 14 is implemented, it allows for simplification of the arrangement involved because there is none of such a residual high-frequency extraction block as shown in FIG. 2.

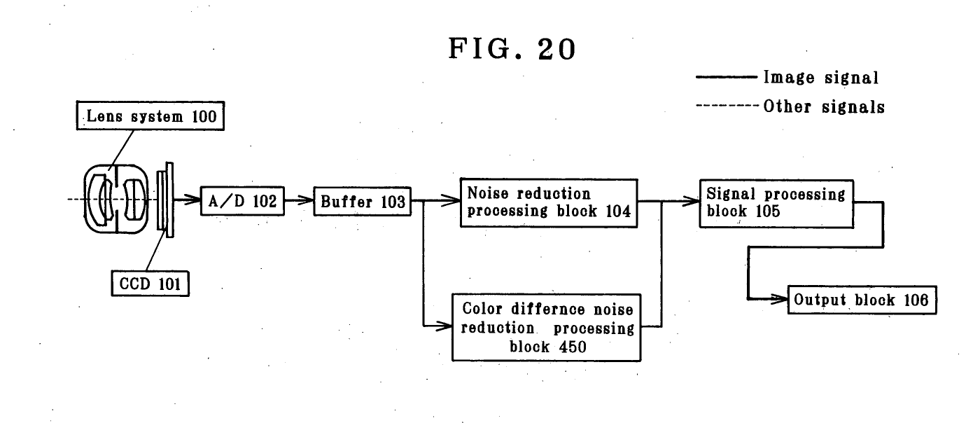

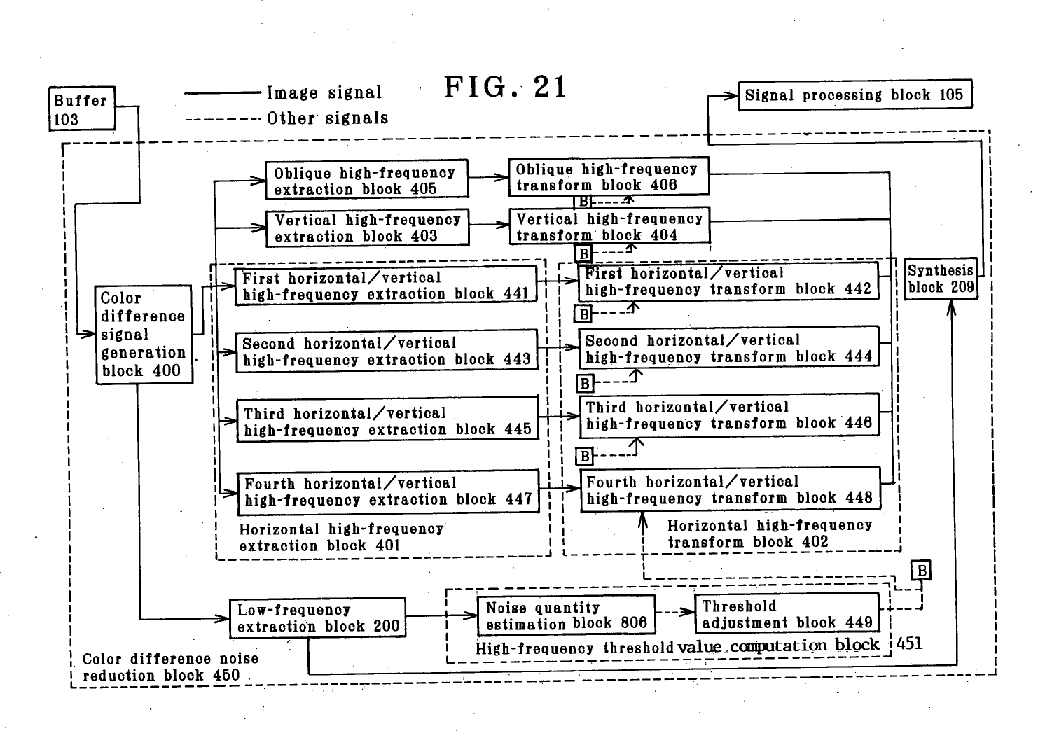

FIGS. 20 and 21 are illustrative of the third embodiment of the invention; FIG. 20 is illustrative of the architecture of the third embodiment and FIG. 21 is illustrative of the setup of a part of the FIG. 20.

In the architecture of FIG. 20, a color difference noise reduction processing block 450 is added to the architecture of the first embodiment shown in FIG. 1. In the third embodiment shown in FIG. 20, noise reduction processing is applied to a luminance signal (G) and a color signal (R-G, B-G), respectively. That is, at the noise reduction processing block 104 noise reduction processing is applied to the luminance signal (G), and at the color difference signal processing block 450 noise reduction processing is applied to the color signal (R-G, B-G). Accordingly, in the third embodiment shown in FIG. 20, the noise reduction processing block 104 is the same in construction and action as that in the first embodiment.

FIG. 21 is illustrative of the color difference noise reduction processing block 450. The embodiment of FIG. 21 is different from the second embodiment of FIG. 14 in that a horizontal high-frequency threshold computation block 451 is built up of a noise quantity estimation block 806 and a threshold adjustment block 449. A horizontal high-frequency extraction block 401 is built up of the first to fourth horizontal high-frequency extraction blocks 441 to 447, and a horizontal high-frequency transform block 402 is built up of the first to fourth horizontal high-frequency transform block 442 to 448. A vertical high-frequency extraction block 403, and an oblique high-frequency extraction block 405, too, is built up of four high-frequency extraction blocks as is the case with the horizontal high-frequency extraction block 402.

At the horizontal high-frequency threshold computation block 451, the same threshold is worked out for components in every direction; in other words, it is not that different thresholds are figured out depending on components in the horizontal, vertical, and oblique directions. At a threshold adjustment block 440, the quantity of noise found at the noise quantity estimation block 806 is adjusted on the basis of the adjustment value set from the control block. The output (B) of this adjustment value is a value for adjusting the intensity of transform processing implemented at the horizontal, vertical, and oblique high-frequency transform blocks 402, 404 and 406: it is entered in each high-frequency transform block 402, 404, 406. The output (B) of the adjustment value is predetermined in such a way as to make sure the desired image quality.

The third embodiment shown in FIGS. 20 and 21 is characterized in that how to determine the threshold for the luminance signal is different from how to the threshold for the color difference signal. This embodiment is much more simplified in terms of construction, because there is no need of making reference to each high-frequency component in the determination of the threshold used for the transform processing of the color difference signal.

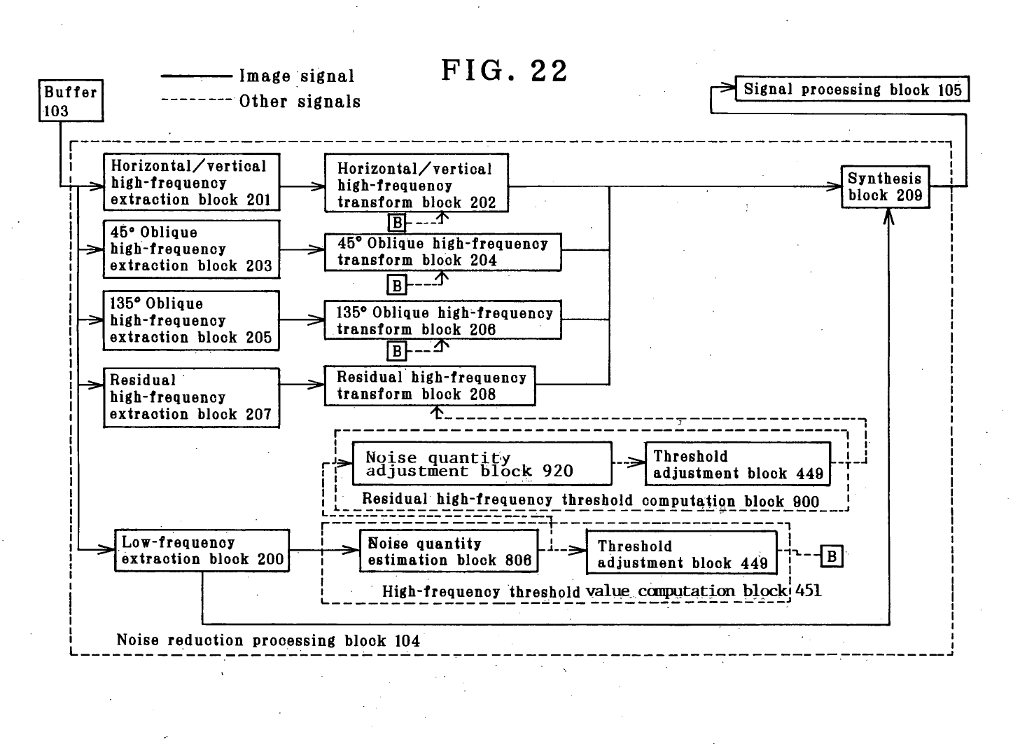

FIG. 22 is illustrative of the architecture of the fourth embodiment according to the invention. In the third embodiment shown in FIG. 20, the noise reduction processing block 104 is configured as shown in FIG. 22. The high-frequency extraction block comprises the horizontal/vertical high-frequency extraction block 201, 45° oblique high-frequency extraction block 203, 135° oblique high-frequency extraction block 205 and residual high-frequency extraction block 207, as is the case with FIG. 2, and the high-frequency transform block comprises the horizontal/vertical high-frequency transform block 202, 45° oblique high-frequency transform block 204, 135° oblique high-frequency transform block 206 and residual high-frequency transform block 208.

A threshold (B) determined at a threshold adjustment block 449 in the high-frequency threshold computation block 451 is provided to the horizontal/vertical, 45° oblique and 135° oblique high-frequency transform processing blocks 202 to 206. A threshold provided to a residual high-frequency transform processing block 910 is determined at the threshold adjustment block 449 in the residual high-frequency threshold computation block 900. The noise quantity estimation block 806 and threshold adjustment block 449 in the high-frequency threshold computation block 451 are similar in construction and action to those in the third embodiment of FIG. 21.

The residual high-frequency threshold computation block 900 comprises a noise quantity adjustment block 920 and the threshold adjustment block 449. The residual high-frequency extraction filter of FIG. 5 forming the residual high-frequency extraction block 207 is different in gain from the high-frequency extraction filters of FIG. 6 forming other high-frequency extraction blocks. For this reason, the noise quantity adjustment block 920 corrects the quantity of noise estimated at the noise quantity estimation block 806 depending on the filter gain difference. It is thus possible to make the noise model set at the noise quantity estimation block 806 shareable among the respective high-frequency components, thereby reducing the capacity needed for memory means with the noise mode stored in it.

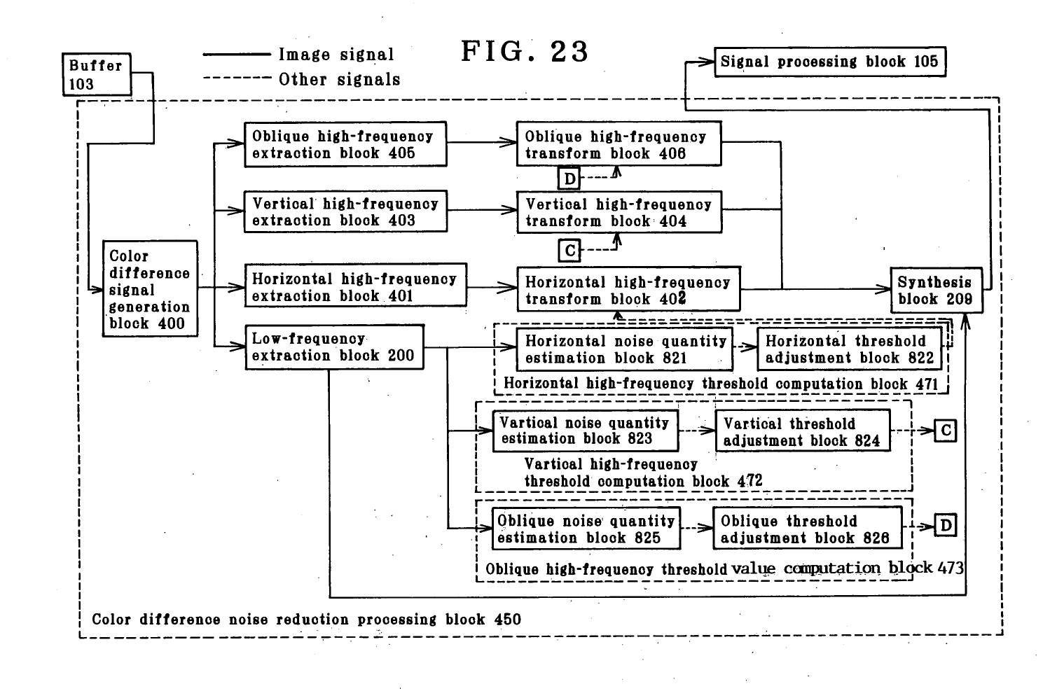

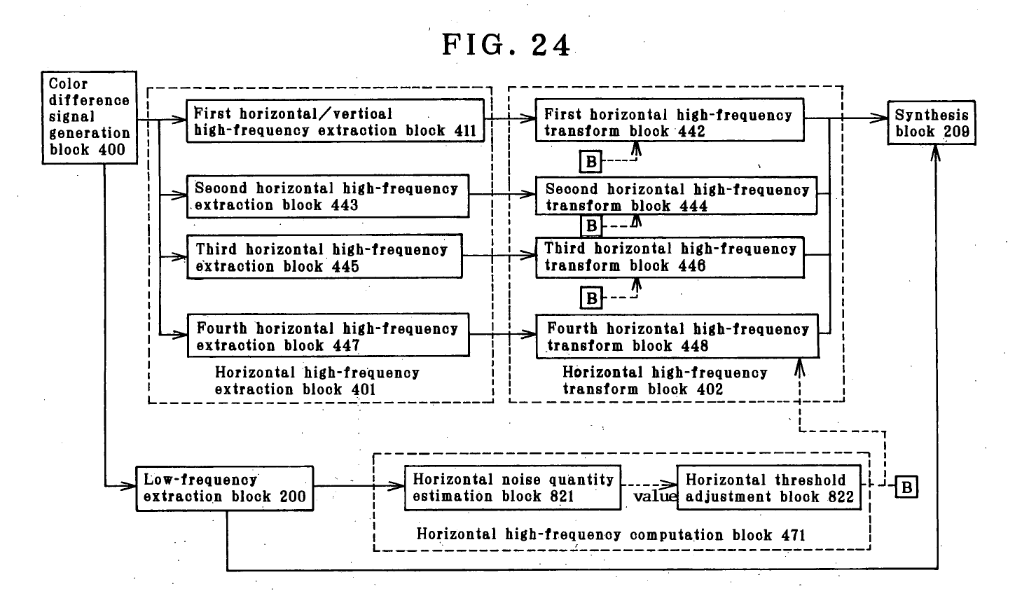

FIGS. 23 and 24 are illustrative of the architecture of the fifth embodiment according to the invention. In the fifth embodiment, the color difference noise reduction processing block 450 in the third embodiment of FIG. 21 is configured as shown in FIG. 23. Referring to FIG. 23, a frequency component extracted at the low-frequency extraction block 200 is entered in the horizontal high-frequency threshold computation block 471, vertical high-frequency threshold computation block 472 and oblique high-frequency threshold computation block 473.

The horizontal high-frequency threshold computation block 471 comprises a horizontal noise quantity estimation block 821 and a horizontal threshold adjustment block 822; the vertical high-frequency threshold computation block 472 comprises a vertical noise quantity estimation block 823 and a vertical threshold adjustment block 824; and the oblique high-frequency threshold computation block 473 comprises an oblique noise quantity estimation block 825 and an oblique threshold adjustment block 826. A threshold (B) given to the horizontal high-frequency transform block 402, a threshold (C) given to the vertical high-frequency transform 404, and a threshold (D) given to the oblique high-frequency transform block 406 are determined at the horizontal high-frequency threshold computation block 471, the vertical high-frequency threshold computation block 472, and the oblique high-frequency threshold computation block 473, respectively.

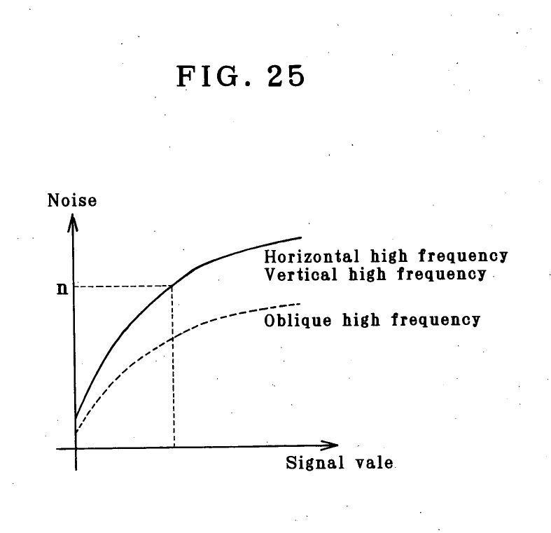

The outputs of the horizontal high-frequency transform block 402, vertical high-frequency transform block 404, oblique high-frequency transform block 406 and low-frequency extraction block 200 are synthesized together at the synthesis block 209, and then entered in the signal processing block 105. In FIG. 23, noise models such as the one shown in the characteristics view of the noise model of FIG. 25 are individually set at the horizontal high-frequency threshold computation block 471, vertical high-frequency threshold computation block 472 and oblique high-frequency threshold computation block 473, and so are the adjustment values for the threshold. By individually setting the noise model and adjustment value at each high-frequency threshold computation block, it is thus possible to change the degree of noise reductions as per direction of high-frequency component.

FIG. 24 is illustrative in details of the horizontal high-frequency component extraction block 401, horizontal high-frequency transform block 402 and horizontal high-frequency threshold computation block 471 in FIG. 23. As shown in FIG. 21, the horizontal high-frequency component extraction block 401 comprises the first to fourth horizontal high-frequency extraction blocks 441 to 447, as shown in FIG. 21. The horizontal high-frequency transform block 402 comprises the first to fourth horizontal high-frequency transform blocks 442 to 448, and the horizontal high-frequency threshold computation block 471 comprises a horizontal noise quantity estimation block 821 and a horizontal threshold adjustment block 822.

The fifth embodiment shown in FIGS. 23 and 24 includes a threshold computation block for each of the horizontal, vertical and oblique directions. It is thus possible to implement threshold processing for each of different directions, thereby preventing the occurrence of artifacts resulting from the remnants of a high-frequency component in a specific direction.

### INDUSTRIAL APPLICABILITY

According to the invention as described above, there is an image processor provided, wherein the image to be processed is separated into multiple frequency components, and processing is applied to the separated frequency components, whereby artifacts resulting from noise can be prevented, and there can be a sensible tradeoff offered between proper noise reductions and maintaining the details of an image.

What we claim is:

1. An image processor, characterized by comprising a low-frequency component creation block for creating from an image of interest a low-frequency component of said image of interest, a high-frequency component creation block for creating from said image of interest at least two high-frequency components of said image of interest, a high-frequency component transform block for enhancing or inhibiting an element of said at least two high-frequency components, which element has a given absolute value range at a given high-frequency component, a threshold setting block for setting at least two thresholds that determine said given absolute value range for high-frequency components of said at least two high-frequency components, in which said high-frequency components lie along mutually similar directions, and an image generation block for using said at least two high-frequency components after transformed at said high-frequency component transform block and said image of interest or said low-frequency component to generate an image.

2. The image processor according to claim 1, characterized in that said threshold setting block sets said thresholds on the basis of a given high-frequency component of said at least two high-frequency components.

3. The image processor according to claim 1, characterized in that said threshold setting block further comprises an average computation block for figuring out an average of a given high-frequency component of said at least two high-frequency components, wherein said average is adjusted and entered in said high-frequency component transform block.

4. The image processor according to claim 3, characterized in that said average computation block further comprises a gain adjustment block for adjusting a gain of said given high-frequency component of said at least two high-frequency components.

5. The image processor according to claim 1, characterized in that said threshold setting block further comprises a noise quantity estimation block for estimating a quantity of noise estimated to be included in a given high-frequency component of said at least two high-frequency components.

6. The image processor according to claim 1, characterized in that said threshold setting block further comprises a threshold limiting block for adding limitation on said threshold.

7. The image processor according to claim 6, characterized in that said threshold limiting block is a lower limit limiting block for limiting said threshold to more than a given lower limit.

8. The image processor according to claim 6, characterized in that said threshold limiting block is an upper limit limiting block for limiting said threshold to less than a given upper limit.

9. The image processor according to claim 6, characterized in that said threshold limiting block further comprises a noise quantity estimation block for estimating a quantity of noise estimated to be included in a given high-frequency component of said at least two high-frequency components.

10. The image processor according to claim 5, characterized in that said noise quantity estimation block further comprises a noise quantity adjustment block for adjusting a quantity of noise estimated to be included in a given high-frequency component to a quantity of noise estimated to be included in other given high-frequency component.
